(19) United States
(12) Patent Application Publication
(10) Pub. No.: US 2021/0051151 A1
(43) Pub. Date: Feb. 18, 2021

(54) METHOD AND SYSTEM FOR AUTOMATED DOMAIN ACCOUNT TERMINATION AND RECONCILIATION

(71) Applicant: JPMorgan Chase Bank, N.A., New York, NY (US)

(72) Inventors: Trevis A. HALLADAY, Wesley Chapel, FL (US); Joseph Brian POTTERBAUM, Tampa, FL (US); Tom KOWALSKI, DELAWARE, OH (US)

(73) Assignee: JPMorgan Chase Bank, N.A., New York, NY (US)

(21) Appl. No.: 16/542,717

(22) Filed: Aug. 16, 2019

(51) Int. Cl. H04L 29/06; G06Q 10/10

(52) U.S. Cl. CPC H04L 63/102; G06Q 10/105; H04L 63/20

(57) ABSTRACT

A method for automatically updating an access control with respect to a network is provided. The method includes obtaining, from within the network, employment status data for a first user, and comparing the employment status data with a most recent version of an employee record for the first user. When there is a change in the employment status to indicate that the employment of the first user has been terminated, an access of the first user to the network is automatically disabled. When the access of the first user is disabled, a notification message is generated and transmitted to one or more recipients.

### BACKGROUND

### 1. Field of the Disclosure

This technology generally relates to methods and systems for ensuring updated access control to computer networks, and more particularly to methods and systems for automating domain account termination and reconciliation with respect to access control.

### 2. Background Information

Large organizations, such as business corporations and governmental entities, typically operate computer networks to which access is controlled in order to ensure system security. Employees and other qualified individuals may be granted access to an organizational network in order to facilitate cooperation in performing tasks or other projects.

When the employment of a person is terminated, it is important to ensure that the terminated employee's access to an organizationally-controlled computer network is removed, in order to protect the organization. In this regard, such an access removal may be time-sensitive, because of the risk that a terminated employee may use the access to the detriment of the organization.

Although conventional systems may include databases that store employee information such as employment status, there is a difficulty in ensuring that a corresponding access removal is executed in a timely manner, especially in an organization for which a number of active employees is large. Accordingly, there is a need to automate an access removal process for terminated employees.

### SUMMARY

The present disclosure, through one or more of its various aspects, embodiments, and/or specific features or sub-components, provides, inter alia, various systems, servers, devices, methods, media, programs, and platforms for automatically updating an access control with respect to a network.

According to an aspect of the present disclosure, a method for automatically updating an access control with respect to a network is provided. The method is implemented by at least one processor. The method includes: obtaining, from within the network, employment status data for a first user; comparing the employment status data with a most recent version of an employee record for the first user; when both of the employment status data and the most recent version of the employee record include information indicating that an employment of the first user is active, waiting for a first predetermined amount of time and then obtaining an updated version of the employment status data for the first user; and when the most recent version of the employee record includes the information indicating that the employment of the first user is active and the employment status data includes information that indicates that the employment of the first user has been terminated, automatically causing a disablement of an access of the first user to the network.

When the access of the first user is disabled, the method may further include generating a notification message that includes information relating to the access disablement and transmitting the notification message to a predetermined destination.

The method may further include receiving a confirmation that the notification message is successfully received.

When a confirmation that the notification message is successfully received is not received within a second predetermined amount of time, the method may further include generating a reminder message that includes information relating to prompting a response from a recipient and transmitting the reminder message to the predetermined destination.

The method may further include logging a first parameter that indicates an identification of the employment termination, a second parameter that indicates a success/failure status of the access disablement, and a third parameter that indicates whether the notification message has been transmitted.

The method may further include verifying a compliance with at least one rule that relates to a Payment Card Industry Data Security Standard (PCI DSS).

The method may further include generating a Service Organization Control 1 (SOC 1) report that relates to a result of executing the method.

The causing the disablement of the access of the first user to the network may be performed by resetting a password that relates to the access of the first user to the network.

The first predetermined amount of time may be less than 24 hours, such as, for example, five hours or less.

According to another aspect of the present disclosure, a computing apparatus configured to implement an execution of a method for automatically updating an access control with respect to a network is provided. The computing apparatus includes a processor, a memory, and a communication interface coupled to each of the processor and the memory. The processor is configured to: obtain, from within the network via the communication interface, employment status data for a first user; compare the employment status data with a most recent version of an employee record for the first user; when both of the employment status data and the most recent version of the employee record include information indicating that an employment of the first user is active, wait for a first predetermined amount of time and then obtain an updated version of the employment status data for the first user; and when the most recent version of the employee record includes the information indicating that the employment of the first user is active and the employment status data includes information that indicates that the employment of the first user has been terminated, automatically cause a disablement of an access of the first user to the network.

When the access of the first user is disabled, the processor may be further configured to generate a notification message that includes information relating to the access disablement and to transmit the notification message via the communication interface to a predetermined destination.

The processor may be further configured to receive, via the communication interface, a confirmation that the notification message is successfully received.

When a confirmation that the notification message is successfully received is not received within a second predetermined amount of time, the processor may be further configured to generate a reminder message that includes information relating to prompting a response from a recipient and to transmit the reminder message via the communication interface to the predetermined destination.

The processor may be further configured to store, in the memory, each of a first parameter that indicates an identification of the employment termination, a second parameter that indicates a success/failure status of the access disablement, and a third parameter that indicates whether the notification message has been transmitted.

The processor may be further configured to verify a compliance with at least one rule that relates to a Payment Card Industry Data Security Standard (PCI DSS).

The processor may be further configured to generate a Service Organization Control 1 (SOC 1) report that relates to a result of executing the method.

The processor may be further configured to cause the disablement of the access of the first user to the network by resetting a password that relates to the access of the first user to the network.

The first predetermined amount of time may be less than 24 hours, such as, for example, five hours or less.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for automating domain account termination and reconciliation for access control with respect to a computer network.

FIG. 4 is a flowchart of an exemplary process for implementing a method for automating domain account termination and reconciliation for access control with respect to a computer network.

FIG. 5 is a data flow diagram that illustrates a sequence of events and data flows that occur during an execution of a method for automating domain account termination and reconciliation for access control with respect to a computer network, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

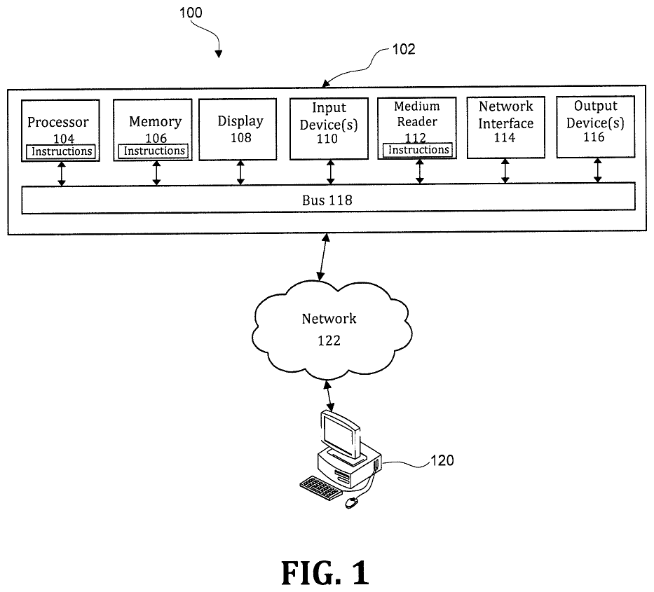

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized methods and systems for automating domain account termination and reconciliation for access control with respect to a computer network.

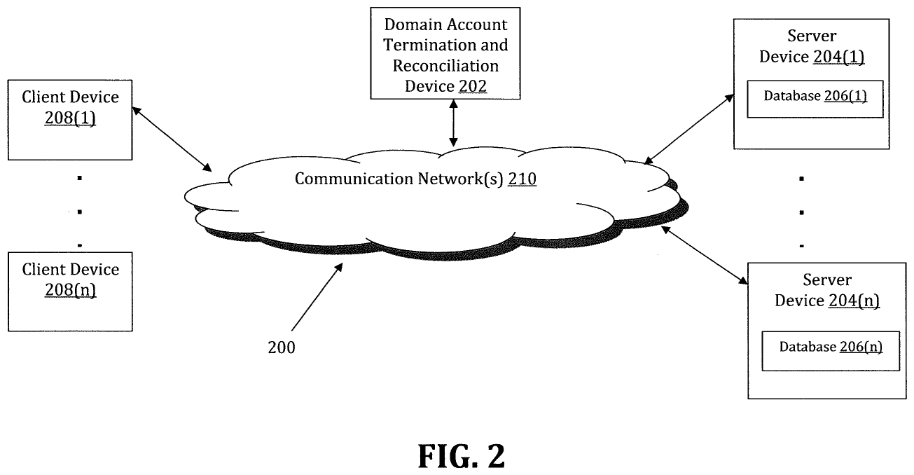

Referring to FIG. 2, a schematic of an exemplary network environment 200 for implementing a method for automating domain account termination and reconciliation for access control with respect to a computer network is illustrated. In an exemplary embodiment, the method is executable on any networked computer platform, such as, for example, a personal computer (PC).

The method for automating domain account termination and reconciliation for access control with respect to a computer network may be implemented by a Domain Account Termination and Reconciliation (DATR) device 202. The DATR device 202 may be the same or similar to the computer system 102 as described with respect to FIG. 1. The DATR device 202 may store one or more applications that can include executable instructions that, when executed by the DATR device 202, cause the DATR device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DATR device 202 itself, may be located in virtual server(s) running in a cloud-based computing environment rather than being tied to one or more specific physical network computing devices. Also, the application(s) may be running in one or more virtual machines (VMs) executing on the DATR device 202. Additionally, in one or more embodiments of this technology, virtual machine(s) running on the DATR device 202 may be managed or supervised by a hypervisor.

In the network environment 200 of FIG. 2, the DATR device 202 is coupled to a plurality of server devices 204(1)-204(n) that hosts a plurality of databases 206(1)-206(n), and also to a plurality of client devices 208(1)-208(n) via communication network(s) 210. A communication interface of the DATR device 202, such as the network interface 114 of the computer system 102 of FIG. 1, operatively couples and communicates between the DATR device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DATR device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and DATR devices that efficiently implement a method for automating domain account termination and reconciliation for access control with respect to a computer network.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DATR device 202 may be a standalone device or integrated with one or more other devices or apparatuses, such as one or more of the server devices 204(1)-204(n), for example. In one particular example, the DATR device 202 may include or be hosted by one of the server devices 204(1)-204(n), and other arrangements are also possible. Moreover, one or more of the devices of the DATR device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DATR device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store human resources data, employment records data, business service data, and data that relates to regulatory requirements.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DATR device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the DATR device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the DATR device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DATR device 202, the server devices 204(1)-204(n), or the client devices 208(1)-208(n), for example, may be configured to operate as virtual instances on the same physical machine. In other words, one or more of the DATR device 202, the server devices 204(1)-204(n), or the client devices 208(1)-208(n) may operate on the same physical device rather than as separate devices communicating through communication network(s) 210. Additionally, there may be more or fewer DATR devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof

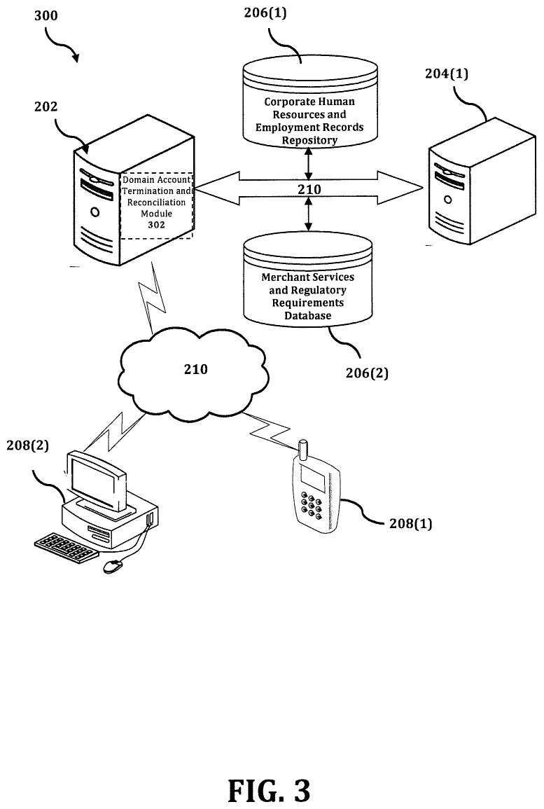

The DATR device 202 is described and shown in FIG. 3 as including a domain account termination and reconciliation module 302, although it may include other rules, policies, modules, databases, or applications, for example. As will be described below, the domain account termination and reconciliation module 302 is configured to implement a method for automating domain account termination and reconciliation for access control with respect to a computer network.

An exemplary process 300 for implementing a mechanism for automating domain account termination and reconciliation for access control with respect to a computer network by utilizing the network environment of FIG. 2 is shown as being executed in FIG. 3. Specifically, a first client device 208(1) and a second client device 208(2) are illustrated as being in communication with DATR device 202. In this regard, the first client device 208(1) and the second client device 208(2) may be “clients” of the DATR device 202 and are described herein as such. Nevertheless, it is to be known and understood that the first client device 208(1) and/or the second client device 208(2) need not necessarily be “clients” of the DATR device 202, or any entity described in association therewith herein. Any additional or alternative relationship may exist between either or both of the first client device 208(1) and the second client device 208(2) and the DATR device 202, or no relationship may exist.

Further, DATR device 202 is illustrated as being able to access a corporate human resources and employment records repository 206(1) and a merchant services and regulatory requirements database 206(2). The domain account termination and reconciliation module 302 may be configured to access these databases for implementing a method for automating domain account termination and reconciliation for access control with respect to a computer network.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the DATR device 202 via broadband or cellular communication. Of course, these embodiments are merely exemplary and are not limiting or exhaustive.

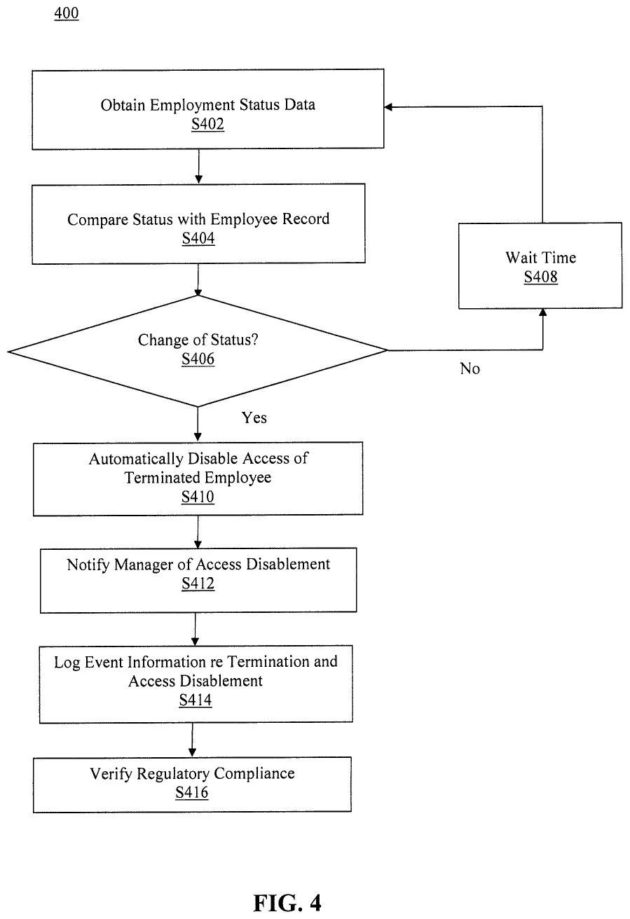

Upon being started, the domain account termination and reconciliation module 302 executes a process for automating domain account termination and reconciliation for access control with respect to a computer network. An exemplary process for automating domain account termination and reconciliation for access control with respect to a computer network is generally indicated at flowchart 400 in FIG. 4.

In the process 400 of FIG. 4, at step S402, employment status data that relates to a first user is obtained. Then, at step 5404, the obtained employment status data is compared with a most recent version of an employee record for the first user. In an exemplary embodiment, the domain account termination and reconciliation module 302 continuously runs a PowerShell script that cycles through employee records, effectively watching for a change in employment status for any employee.

At step S406, a determination is made as to whether a status change has occurred. If no status change occurs, then at step S408, the domain account termination and reconciliation module 302 continues cycling through other employee records, which effectively requires a wait time that corresponds to a predetermined amount of time. In an exemplary embodiment, the effective wait time may be less than 24 hours, such as, for example, five hours or less, i.e., an amount of time that is required for the PowerShell script to cycle through all employee records.

If a status change is detected, then at step S410, the domain account termination and reconciliation module 302 automatically disables the access to the network that had previously been provided to the newly terminated employee. In an exemplary embodiment, the automatic access disablement may be implemented by resetting a password that had previously been used by the employee to access the network.

At step S412, the domain account termination and reconciliation module 302 generates a notification message that includes information relating to the access disablement, and then transmits the notification message to at least one person and/or entity, such as, for example, a manager, in order to ensure that appropriate personnel are aware of the action that has been taken. Then, at step S414, the domain account termination and reconciliation module 302 logs relevant events that relate to the termination and the access disablement. In an exemplary embodiment, the logging of events may entail using Splunk software in conjunction with corporate human resources and employee records repository 206(1) to store various informational parameters, such as, for example, a job start date, a job completion date, a termination identification parameter, an account disablement success/failure parameter, and a notification transmission parameter that includes information identifying a person or entity to which the notification message has been sent.

At step S416, the domain account termination and reconciliation module 302 verifies compliance with any and all applicable rules and regulations. In an exemplary embodiment, the organization may be subject to the Payment Card Industry Data Security Standard (PCI DSS), and an applicable rule may entail generating a Service Organization Control 1 (SOC 1) report that facilitates auditing of the process 400. In an exemplary embodiment, the domain account termination and reconciliation module 302 accesses information relating to applicable rules and regulations from merchant services and regulatory requirements database 206(2).

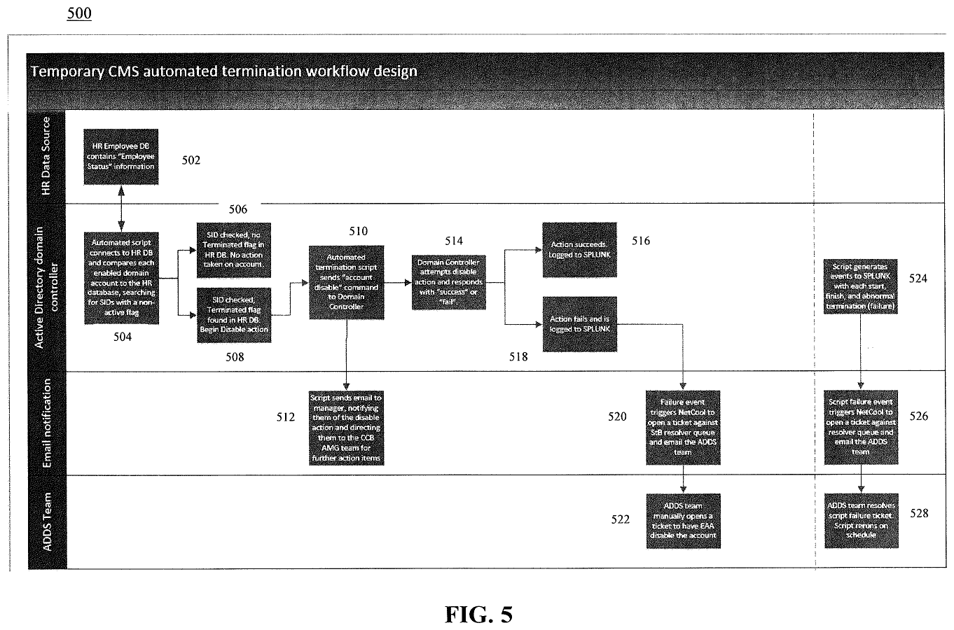

FIG. 5 is a data flow diagram 500 that illustrates a sequence of events and data flows that occur during an execution of a method for automating domain account termination and reconciliation for access control with respect to a computer network, according to an exemplary embodiment. As illustrated in FIG. 5, at step 502, a human resources employee database (HR DB) contains “Employee Status” information, and at step 504, an automated script connects to the HR DB and compares each enabled domain account thereto, searching for a non-active flag that indicates that the employment status of a previously active employee is now a terminated status.

At step 506, if no “Terminated” flags are found, then no further action is taken on the account until the script is executed anew. Alternatively, at step 508, if a “Terminated” flag is found, then a Disable action begins.

At step 510, an automated termination script sends an “account disable” command to a domain controller. At step 512, an email notification message is sent to a manager in order to notify the manager of the disable action and to direct the manager to other personnel for further action items. At step 514, in response to the “account disable” command,” the domain controller attempts to implement the disable action and responds with a “success” or a “fail” indication. At step 516, if the disable action succeeds, the events are logged to a SPLUNK module.

At step 518, if the action fails, the events are logged to the SPLUNK module, and then at step 520, the failure event causes the generation of a failure notification, which is sent to appropriate personnel. Then, at step 522, the account disablement is performed manually in response to the failure notification.

At step 524, the automated script generates event information for each start, finish, and abnormal termination of the script, and logs the information to the SPLUNK module. At step 526, if an abnormal termination of the script occurs, a failure notification is generated and sent to appropriate personnel. Then, at step 528, the script failure is manually resolved, thereby enabling the script to be executed in accordance with a predetermined schedule.

Accordingly, with this technology, an optimized process for automating domain account termination and reconciliation for access control with respect to a computer network is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for automatically updating an access control with respect to a network, the method being implemented by at least one processor, the method comprising:
obtaining, from within the network, employment status data for a first user;
comparing the employment status data with a most recent version of an employee record for the first user;
when both of the employment status data and the most recent version of the employee record include information indicating that an employment of the first user is active, waiting for a first predetermined amount of time and then obtaining an updated version of the employment status data for the first user; and
when the most recent version of the employee record includes the information indicating that the employment of the first user is active and the employment status data includes information that indicates that the employment of the first user has been terminated, automatically causing a disablement of an access of the first user to the network.

2. The method of claim 1, wherein when the access of the first user is disabled, the method further comprises generating a notification message that includes information relating to the access disablement and transmitting the notification message to a predetermined destination.

3. The method of claim 2, further comprising receiving a confirmation that the notification message is successfully received.

4. The method of claim 2, wherein when a confirmation that the notification message is successfully received is not received within a second predetermined amount of time, generating a reminder message that includes information relating to prompting a response from a recipient and transmitting the reminder message to the predetermined destination.

5. The method of claim 2, further comprising logging a first parameter that indicates an identification of the employment termination, a second parameter that indicates a success/failure status of the access disablement, and a third parameter that indicates whether the notification message has been transmitted.

6. The method of claim 1, further comprising verifying a compliance with at least one rule that relates to a Payment Card Industry Data Security Standard (PCI DSS).

7. The method of claim 1, further comprising generating a Service Organization Control 1 (SOC 1) report that relates to a result of executing the method.

8. The method of claim 1, wherein the causing the disablement of the access of the first user to the network comprises resetting a password that relates to the access of the first user to the network.

9. The method of claim 1, wherein the first predetermined amount of time is less than 24 hours.

10. The method of claim 1, wherein the first predetermined amount of time is five hours or less.

11. A computing apparatus configured to implement an execution of a method for automatically updating an access control with respect to a network, the computing apparatus comprising:
a processor;
a memory; and
a communication interface coupled to each of the processor and the memory,
wherein the processor is configured to:
obtain, from within the network via the communication interface, employment status data for a first user;
compare the employment status data with a most recent version of an employee record for the first user;
when both of the employment status data and the most recent version of the employee record include information indicating that an employment of the first user is active, wait for a first predetermined amount of time and then obtain an updated version of the employment status data for the first user; and
when the most recent version of the employee record includes the information indicating that the employment of the first user is active and the employment status data includes information that indicates that the employment of the first user has been terminated, automatically cause a disablement of an access of the first user to the network.

12. The computing apparatus of claim 11, wherein when the access of the first user is disabled, the processor is further configured to generate a notification message that includes information relating to the access disablement and to transmit the notification message via the communication interface to a predetermined destination.

13. The computing apparatus of claim 12, wherein the processor is further configured to receive, via the communication interface, a confirmation that the notification message is successfully received.

14. The computing apparatus of claim 12, wherein when a confirmation that the notification message is successfully received is not received within a second predetermined amount of time, the processor is further configured to generate a reminder message that includes information relating to prompting a response from a recipient and to transmit the reminder message via the communication interface to the predetermined destination.

15. The computing apparatus of claim 12, wherein the processor is further configured to store, in the memory, each of a first parameter that indicates an identification of the employment termination, a second parameter that indicates a success/failure status of the access disablement, and a third parameter that indicates whether the notification message has been transmitted.

16. The computing apparatus of claim 11, wherein the processor is further configured to verify a compliance with at least one rule that relates to a Payment Card Industry Data Security Standard (PCI DSS).

17. The computing apparatus of claim 11, wherein the processor is further configured to generate a Service Organization Control 1 (SOC 1) report that relates to a result of executing the method.

18. The computing apparatus of claim 11, wherein the processor is further configured to cause the disablement of the access of the first user to the network by resetting a password that relates to the access of the first user to the network.

19. The computing apparatus of claim 11, wherein the first predetermined amount of time is less than 24 hours.

20. The computing apparatus of claim 11, wherein the first predetermined amount of time is five hours or less.
